(19) United States
(12) Patent Application Publication
(10) Pub. No.: US 2006/0123895 A1
(43) Pub. Date: Jun. 15, 2006

(54) Drive head and personal atomic force microscope having the same

(75) Inventors: Sung Q. Lee, Daejeon (KR); Kang Ho Park, Daejeon (KR); Eun Kyoung Kim, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/298,041

(22) Filed: Dec. 8, 2005

(30) Foreign Application Priority Data
Dec. 10, 2004 (KR) 2004-104292
Jul. 14, 2005 (KR) 2005-63721

(51) Int. Cl. G01B 5/28

(52) U.S. Cl. 73/105

(57) ABSTRACT

Provided are a drive head and a personal atomic force microscope having the same, and the drive head includes a cantilever provided with a bend detector and for moving a probe, a drive head for moving the cantilever up and down, and a scanner for moving a sample in x- and y-axis directions. The cantilever has a simple structure provided with the bend detector, and the drive head and the scanner are bi-directionally movable and have a large displacement due to the elasticity of the flexible hinge. The personal atomic force microscope has little hysteresis or creep due to its high linearity. Therefore, there is no necessity of a separate sensor system for calibration, and it is possible to obtain a desired image through a single initial calibration.

### CROSS-REFERENCE TO RELATED APPLICATION

This application claims priority to and the benefit of Korean Patent Application Nos. 2004-104292, filed on Dec. 10, 2004, and 2005-63721, filed on Jul. 14, 2005, the disclosure of which is incorporated herein by reference in its entirety.

### BACKGROUND

1. Field of the Invention

The present invention relates to a drive head and a personal atomic force microscope having the same and, more particularly, to a drive head and a personal atomic force microscope having the same, which is movable upward and downward within a large range.

2. Discussion of Related Art

A scanning probe microscope (SPM) that can measure shapes and characteristics of a surface at a nano meter level performs an important function in a research activity on nano technology, which includes a scanning tunneling microscope (STM), an atomic force microscope (AFM), and so on.

The STM includes a sharp-ended probe. When the probe is closed to a surface of a conductive sample and a voltage is applied to the probe and the conductive sample, electrons pass through an energy barrier to allow current to flow if two conductors are very close to each other, which is so called “quantum mechanical tunneling”. On the other hand, when a gap between the probe and the sample is widened, the tunneling probability of the electrons is sharply decreased to rapidly reduce the current. At this time, a scanner adjusts the height of the probe such that uniform current flows through the probe, and moves the probe laterally and reciprocally to measure the surface of the sample. However, the STM cannot measure a non-conductive sample.

On the other hand, the AFM can also measure a non-conductive sample.

The AFM includes a cantilever easily bendable up and down by fine force, and a probe installed at a distal end of the cantilever. When the probe is closed to a surface of the sample, attraction or repulsion is generated between atoms at an end of the probe and the surface of the sample. Various methods have been proposed to measure the bend of the cantilever generated at this time.

Methods of maintaining a uniform gap between the probe and the sample by irradiating light to the cantilever and detecting an angle of the light reflected from the cantilever through a photodiode are disclosed in U.S. Pat. No. 5,955,660, assigned to Seiko Instrument, entitled “Method of controlling probe microscope” and U.S. Pat. No. 6,185,991, assigned to PSIA Corp., entitled “Method and apparatus for measuring characteristics of surface using electrostatic force modulation microscopy which operates in contact mode”.

Technologies for mounting sensors on the cantilever to detect the bend of the cantilever have been developed as disclosed in Sensor and Actuators 83 (2000), pp47-53, entitled “Atomic force microscopy probe with piezoresistive read-out and a highly symmetrical Wheatstone bridge arrangement” by J. Thaysen et al., and U.S. Pat. No. 6,422,069, assigned to Seiko Instrument Inc., entitled “Self-exciting and self-detecting probe and scanning probe apparatus”.

While resolution of the AFM is decreased in the case of the sensor mounted on the cantilever rather than the case of using a laser diode and a photodiode, its alignment and measurement can be readily performed. However, since the conventional AFM uses a piezoelectric driver for movement in x, y and z-axis directions, hysteresis or creep may be generated due to characteristics of the piezoelectric driver, and post-calibration should be performed due to curvilinear motion of the driver generated during scanning in x, y and z-axis directions. As described above, the conventional AFM having an optical structure using the laser diode and the photodiode is complex and has non-linearity due to the hysteresis and creep according to use of the piezoelectric driver, thereby requiring an additional system for solving the problems caused by the non-linearity and increasing the manufacturing cost.

### SUMMARY OF THE INVENTION

The present invention is directed to a drive head vertically movable within a large range.

The present invention is also directed to a personal atomic force microscope which has a simple structure and can manufacture at low cost.

One aspect of the present invention is to provide a drive head including: a flexible hinge having an elastic portion at a predetermined portion; a supporter for supporting the flexible hinge and applying a predetermined force to the elastic portion of the flexible hinge; a yoke connected to the flexible hinge at a position corresponding to the supporter; a magnet projected from the yoke in one direction; and a coil fixed on the supporter and overlapping the magnet.

Another aspect of the present invention is to provide a personal atomic force microscope including: a probe located on a sample; a cantilever for moving the probe; a bend detector with an electric conductivity varying according to a degree of bend of the cantilever; a controller outputting a control signal according to the electric conductivity provided from the bend detector; a drive head for moving the cantilever up and down to uniformly maintain a gap between the probe and the sample in response to the control signal; and a scanner for moving the sample, wherein the drive head comprises: a flexible hinge connected to the cantilever and having an elastic portion at a predetermined portion; a supporter for supporting the flexible hinge and applying a predetermined force to the elastic portion of the flexible hinge; a yoke connected to the flexible hinge at a position corresponding to the supporter; a magnet projected from the yoke in one direction; and a coil fixed on the supporter and overlapping the magnet.

### BRIEF DESCRIPTION OF THE DRAWINGS

The above and other features of the present invention will be described in reference to certain exemplary embodiments thereof with reference to the attached drawings in which:

FIG. 1 is a cross-sectional view of a drive head in accordance with an exemplary embodiment of the present invention;

FIG. 2 is a schematic view illustrating operation of a drive head in accordance with an exemplary embodiment of the present invention;

FIG. 3 is a perspective view of a flexible hinge shown in FIG. 1;

FIG. 4 is a schematic view of an atomic force microscope in accordance with an exemplary embodiment of the present invention;

FIGS. 5 to 7 are plan views of a scanner shown in FIG. 4;

FIG. 8 is a cross-sectional view of a voice coil motor (VCM) for moving a stage shown in FIG. 6;

FIG. 9 is a graph showing the hysteresis measurement result of a personal atomic force microscope in accordance with an exemplary embodiment of the present invention;

FIG. 10 is a photograph of a grating sample obtained by a personal atomic force microscope in accordance with an exemplary embodiment of the present invention; and

FIG. 11 is a cross-sectional view taken along line A1-A2 of FIG. 10.

### DETAILED DESCRIPTION OF EXEMPLARY EMBODIMENTS

Hereinafter, an exemplary embodiment of the present invention will be described in detail. However, the present invention is not limited to the embodiments disclosed below, but can be implemented in various types. Therefore, the present embodiment is provided for complete disclosure of the present invention and to fully inform the scope of the present invention to those ordinarily skilled in the art.

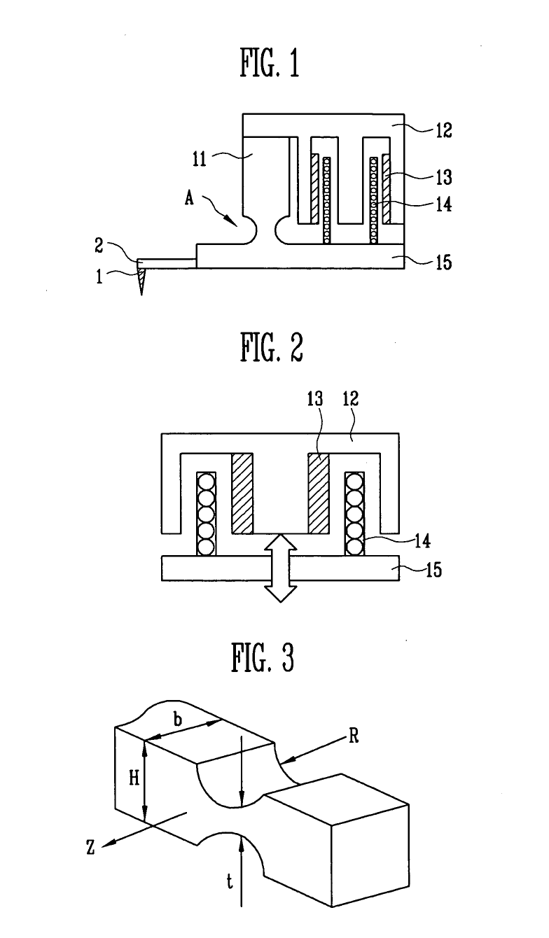

FIG. 1 is a cross-sectional view of a drive head in accordance with an exemplary embodiment of the present invention.

Referring to FIG. 1, the drive head in accordance with an exemplary embodiment of the present invention includes: a flexible hinge 11 having an elastic portion formed at a predetermined portion; a supporter 15 supporting the flexible hinge 11 and applying a predetermined force to the elastic portion of the flexible hinge 11; a yoke 12 connected to the flexible hinge 11 at a position corresponding to the supporter 15; a magnet 13 projected from the yoke 12 in one direction; and a coil 14 fixed on the supporter 15 and overlapping the magnet 13.

In this process, the supporter 15 and the flexible hinge 11 may be formed of an aluminum alloy, and the predetermined portion of the flexible hinge 11 having elasticity is formed in a semi-circular, V or U-shaped groove to smooth the bend of the flexible hinge, as shown in A-portion of FIG. 1.

At this time, while the predetermined portion (an elastic portion) of the flexible hinge 11 is formed at a lower end of the flexible hinge 11 connected to the supporter 15 as shown in FIG. 1, but not limited thereto, the elastic portion may be formed at any part of a body of the flexible hinge 11.

In addition, the magnet 13 installed at the yoke 12 is formed of a rod or cylinder-shaped permanent magnet, and the coil 14 is wound to have a hollow circular or rectangular pipe shape and located inside or outside the magnet 13, thereby overlapping the magnet 13.

As shown in FIG. 1, the coil 14 is located inside the magnet 13, and the coil 14 and the magnet 13 function as a voice coil motor (VCM).

That is, the coil 14 and the magnet 13 generate Lorentsz force F in a specific direction, and the Lorentz force F moves the supporter 15 having the coil 14 upward or downward.

The operation of the drive head will be described as follows. First, when a predetermined current I flows through the coil 14, a direction of a magnetic field B formed by the magnet 13 is perpendicular to a direction of the current I flowing through the coil 14 to generate Lorentz force F, and the supporter 15 having the coil 14 is moved up or down by the Lorentz force F.

Therefore, the upward or downward force generated by the movement of the supporter 15 is transmitted to the flexible hinge 11 connected to the supporter 15 so that the flexible hinge 11 is laterally moved by elasticity of the elastic portion A of the flexible hinge 11 to move a cantilever 2 up or down when an object such as the cantilever 2 is connected to a distal end of the supporter 15.

That is, the drive head can be installed at the personal atomic force microscope. In this case, the cantilever 2 for moving a probe 1 located on the sample can be installed at the distal end of the supporter 15 such that the cantilever 2 is bent up or down.

Hereinafter, the operation of the drive head will be described in conjunction with FIGS. 2 and 3.

FIG. 2 is a schematic view illustrating the operation of a drive head in accordance with an exemplary embodiment of the present invention, functioning as a voice coil motor (VCM), and FIG. 3 is a perspective view of the flexible hinge shown in FIG. 1.

Referring to FIG. 2, the voice coil motor installed in the drive head in accordance with an exemplary embodiment of the present invention includes a yoke 12, a magnet 13 installed at the yoke 12, a coil 14 wound inside or outside the magnet 13, and a supporter 15 supporting the coil 14.

While FIG. 2 illustrates the coil wound outside the magnet 13, but it is only one embodiment.

When the current I flows through the coil 14 in the state that the magnetic field B is formed by the magnet 13, a direction of the magnetic field B formed by the magnet 13 is perpendicular to a direction of the current I flowing through the coil 14 to generate Lorentz force F. The Lorentz force F generated at this time is determined as the following formula 1 according to magnetic flux density B, current I, winding number n of the coil 14, and effective length Le obtained in a portion (space) of the yoke 12.
F=nBILₑ [Formula 1]

Here, since the magnetic flux density B obtained by a magnet circuit is calculated through a complex process and well known through an operation theory of a voice coil motor, its description will be omitted.

That is, referring to FIG. 1, when the supporter 15 with the coil 14 is moved upward by the force F, the flexible hinge 11 connected to the supporter 15 is bent rightward by elasticity of the elastic portion A so that the supporter 15 with the flexible hinge 11 fixed thereto is driven downward to thereby allow the cantilever 2 connected to the supporter 15 to be moved downward.

On the contrary, when the supporter 15 with the coil 14 is moved downward by the force B, the flexible hinge 11 connected to the supporter 15 is bent leftward by elasticity of the elastic portion A so that the supporter 15 with the flexible hinge 11 fixed thereto is driven upward to thereby allow the cantilever 2 connected to the supporter 15 to be moved upward.

In this process, the flexible hinge 11 shown in FIG. 3 can be designed through the following formulae 2 to 6 representing a relationship of force and displacement applied by movement of the supporter 15.

A transformation angle θ z of the flexible hinge 11 is equal to the following formula 2.

$${θ}_{z} = \frac{9 {πR}^{1 / 2} M}{2 {Ebt}^{5 / 2}} \cdot \frac{24 KRM}{{Ebt}^{3}} \qquad [ Formula 2 ]$$

wherein, t<R<5t

A correction factor k is equal to the following formula 3.
k=0.565t/R+0.166 [Formula 3]

Maximum moment of inertia Mₘₐₓ is equal to the following formula 4.

$${M}_{max} = \frac{{bt}^{2}}{6 {K}_{t}} {σ}_{max} \text{:} {σ}_{max} = ( 0.1 \sim 0.3 ) {σ}_{y} \qquad [ Formula 4 ]$$

Stress concentration factor kt is equal to the following formula 5.

$${K}_{t} = \frac{2.7 t + 5.4 R}{8 R + E} + 0.325 \qquad [ Formula 5 ]$$

At this time, a maximum transformation angle θ max can be obtained through the following formula 6. However, since it should be driven within an elastic range, a safety factor of 0.1˜0.3 based on the maximum stress value is determined and designed.

$${θ}_{max} = \frac{4 KR}{{K}_{t} Et} {σ}_{max} \qquad [ Formula 6 ]$$

As can be seen from the formulae 2 to 6, since the thickness b and the width H of the flexible hinge 11 shown in FIG. 3, and the radius R of the groove A are variables, the flexible hinge 11 can be designed on the basis of the required transformation angle and displacement.

FIG. 4 is a schematic view of a personal atomic force microscope with a drive head in accordance with an exemplary embodiment of the present invention as shown in FIG. 1.

As shown in FIG. 4, the personal atomic force microscope in accordance with an exemplary embodiment of the present invention includes a probe 1 located on a sample 9; a cantilever 2 for moving the probe 1, a bend detector 3 having an electric conductivity varying according to the degree of bend of the cantilever 2, a controller 4 outputting a control signal according to the electric conductivity provided from the bend detector 3, and a drive head 7 for moving the cantilever 2 up and down to uniformly maintain a gap between the probe 1 and the sample 9 according to the control signal, wherein the drive head 7 is implemented as the drive head described through FIGS. 1 to 3.

The sample 9 is located on the scanner 10 to be moved in x- and y-axis directions by the scanner 10. A wedge member 8 for locating the cantilever 2 in a predetermined slope may be installed between the drive head 7 and the cantilever 2.

The bend detector 3 detects the degree of bend of the cantilever 2 by force applied between the probe 1 and the sample 9 to indicate variations of resistance, i.e., electric conductivity according to the degree of transformation of the cantilever 2. The bend detector 3 may be formed of an ion-doped layer having piezoresistive characteristics disposed on the cantilever 2, or formed by attaching a material having piezoresistive characteristics outside the cantilever 2.

The controller 4 includes a voltage generator 5 for outputting a voltage signal in response to the electrical conductivity, and an actuator 6 for outputting a control signal having a predetermined current in response to the voltage signal. The voltage generator 5 may be composed of a digital signal processor (DSP), and so on.

As shown in FIG. 1, the drive head 7 includes: a flexible hinge 11 connected to the cantilever 2 at its one end and having an elastic portion formed at a predetermined portion; a supporter 15 supporting the flexible hinge 11 and applying a predetermined force to the elastic portion of the flexible hinge 11; a yoke 12 connected to the flexible hinge 11 at a position corresponding to the supporter 15; a magnet 13 projected from the yoke 12 in one direction; and a coil 14 fixed on the supporter 15 and overlapping the magnet 13.

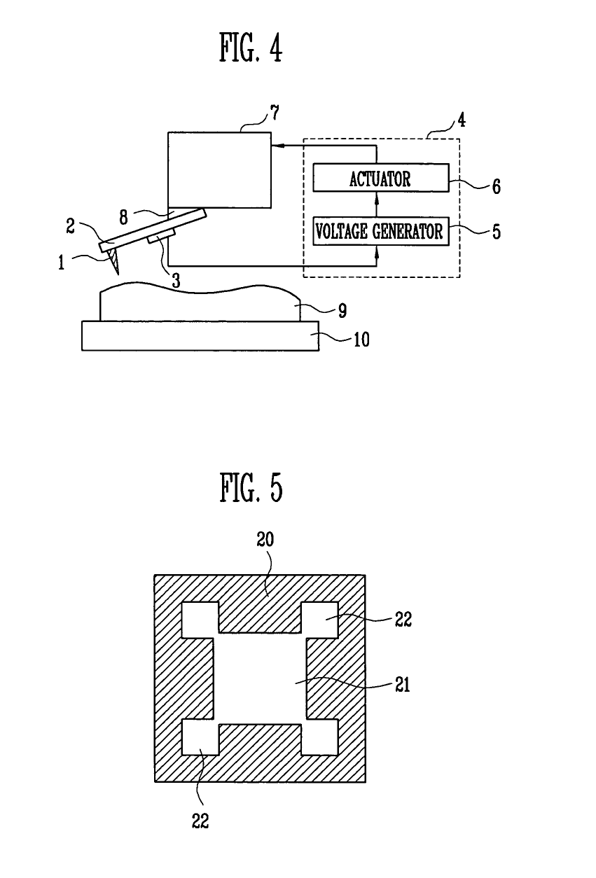

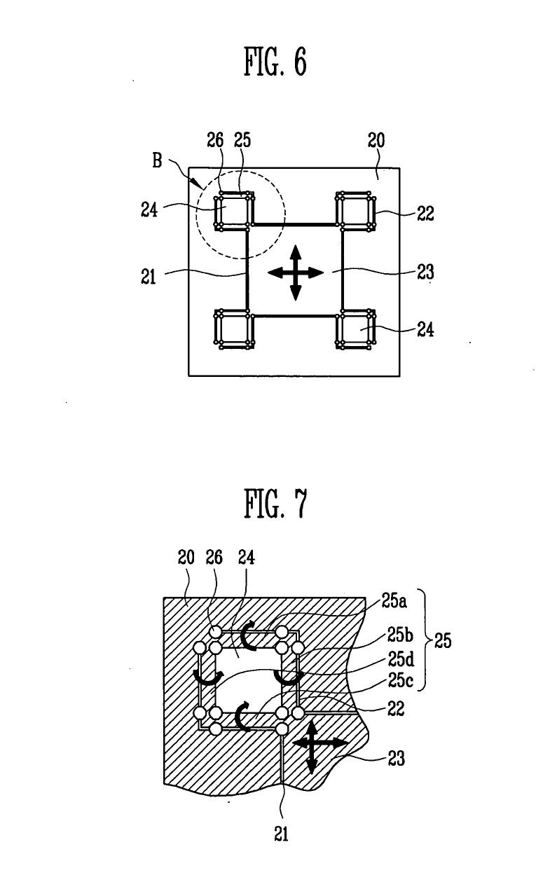

FIGS. 5 to 7 are plan views of the scanner 10 shown in FIG. 4.

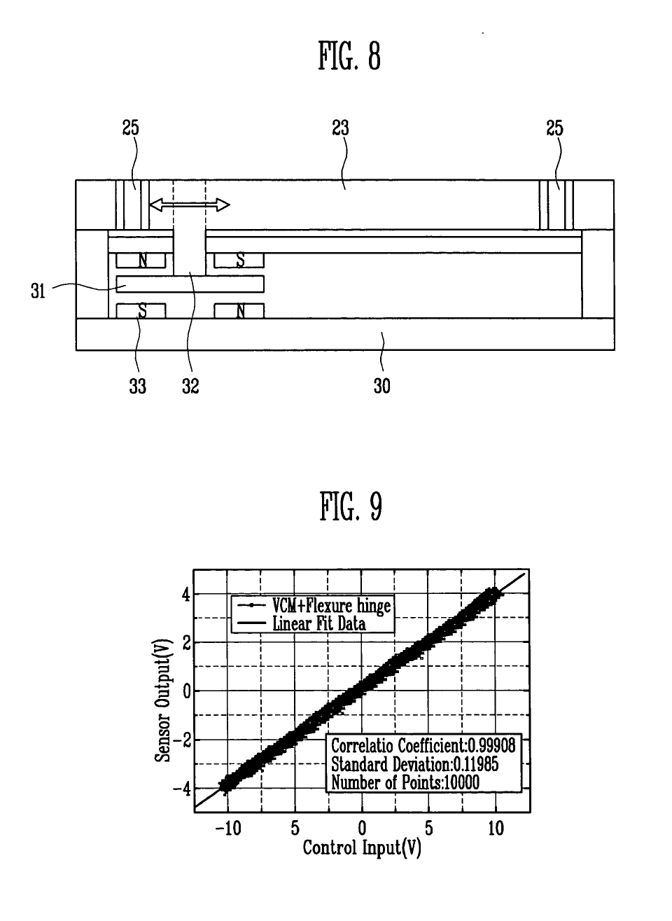

As shown in FIGS. 5 to 7, the scanner 10 includes: a frame 20 (see FIG. 5) having a rectangular-shaped first opening 21 formed at a center portion and rectangular-shaped second openings 22 formed at each corner of the first opening 21; a rectangular-shaped stage 23 placed in the first opening 21 and for placing the sample 9; and flexible hinges 25 placed in each of the second openings 22, having two opposite corners, i.e., lower right and upper left corners shown in FIG. 7, connected to the stage 23 and the frame 20, and having a rectangular-shaped third opening 24 formed at each center (see FIGS. 6 and 7). FIG. 7 is an enlarged view of B-portion in FIG. 6.

In this process, as shown in FIG. 7, the flexible hinges 25 includes first to fourth flexible hinge portions 25a, 25b, 25c and 25d connected to each other and spaced apart from the frame 20. Preferably, each of the flexible hinge portions 25a, 25b, 25c and 25d is designed in the same manner as the flexible hinge 11 of the drive head 7.

That is, preferably, in order to allow each of the flexible hinge portions 25a, 25b, 25c and 25d to be smoothly bent, the flexible hinge portions have elastic portions formed at its proximal end and having a width smaller than that of a center portion.

For this purpose, as shown in FIG. 7, a plurality of circular holes 26 may be formed to have the elastic portion at the proximal end of the flexible hinge portion.

The stage 23 is moved in x- and y-axis directions by a voice coil motor (VCM), and therefore, the first to fourth flexible hinge portions 25a, 25b, 25c and 25d composing the flexible hinge 25 are bent in y and x-axis directions as shown in FIG. 7.

That is, the first and third flexible hinge portions 25a and 25c located at upper and lower sides of the second opening 22 and opposite to each other are bent in the y-axis direction by the movement of the stage 23, and the second and fourth flexible hinge portions 25b and 25d located at left and right sides of the second opening 22 and opposite to each other are bent in the x-axis direction by the movement of the stage 23 as shown in FIG. 7.

As shown in FIG. 8, the VCM includes a yoke 30 located under the stage 23, two pairs of magnets 33 attached to the yoke 30 and disposed opposite to each other, a coil 31 disposed perpendicular to a direction of a magnetic field formed between the magnets 33, and a movable shaft 32 fixed to the coil 31 and the stage 23. The direction of the magnetic field is determined by the two pairs of magnets 33, and the stage 23 is moved as the movable shaft 32 connected to the coil 31 is moved in the x- and y-axis directions according to the direction of the magnetic filed and the direction of current flowing through the coil 31.

For example, when the stage 23 is moved in the x-axis direction by the VCM, the second and fourth flexible hinge portions 25b and 25d of the flexible hinge 25 are bent, and when the stage 23 is moved in the y-axis direction, the first and third flexible hinge portions 25a and 25c of the flexible hinge 25 are bent, thereby moving the sample 9 in the x- and y-axis directions.

At this time, in order to maintain the entire equilibrium, since the first to fourth flexible hinge portions 25a, 25b, 25c and 25d composing each flexible hinge 25 should be bent to have the same displacement (for example, more than 100 μm), the flexible hinge portions should have the same elasticity.

Therefore, since the bend of the flexible hinge 25 in the x- and y-axis directions functions as a guide of a moving path of the stage 23, the stage 23 can be precisely moved in the x- and y-axis directions without distortion.

Hereinafter, the operation of the personal atomic force microscope in accordance with an exemplary embodiment of the present invention will be described.

The sample 9, which is to be measured, is located on the stage 23 of the scanner 10, and the cantilever 2 is moved to make the probe 1 close to a surface of the sample 9. When the probe 1 is closed to the sample 9, the probe 1 and the sample 9 interact to generate force to cause the cantilever 2 to be bent upward.

At this time, since the degree of bend of the cantilever 2 is represented as variations of an electrical conductivity of the bend detector 3, the voltage generator 5 transmits a voltage signal according to the electrical conductivity to the actuator 6, and the actuator 6 supplies a control signal having a current according to the voltage signal to the coil 14 of the drive head 7.

Since a predetermined amount of current I flows through the coil 14 and a direction of the magnetic field B formed by the magnet 13 is perpendicular to a direction of the current I flowing through the coil 14, the supporter 15 provided with the coil 14 moves up or down by the Lorentz force, and the cantilever 2 connected to the end of the supporter 15 moves down or up by the elasticity of the flexible hinge 11.

Through the feedback process, a gap between the probe 1 and the sample 9, i.e., the height of the probe 1 is uniformly maintained and the scanner 10 moves in the x- and y-axis directions, thereby measuring the entire surface of the sample 9.

That is, a value of a z-axis is obtained according to the position of the x and y axes to thereby gain a spatial shape of the sample 9.

The drive head of the present invention can be bi-directionally moved according to the direction of the current flow and configured to maximize the displacement using the maximum elasticity of the flexible hinge. Therefore, the personal atomic force microscope employing the drive head in accordance with an exemplary embodiment of the present invention has a longitudinal displacement larger than that of the head of the conventional atomic force microscope.

In addition, since the scanner of the present invention has a symmetric structure, the scanner is less sensitive to heat, vibration, disturbance and so on, and has the same bi-directional dynamic characteristics. Further, since there is no hysteresis or creep, there is no distortion of images according to a scanning direction, and therefore, the scanner has a displacement larger than that of the stage of the conventional atomic force microscope by using the elasticity of the flexible hinge maximally.

FIG. 9 is a graph showing the hysteresis measurement result of a personal atomic force microscope in accordance with an exemplary embodiment of the present invention.

The displacement of the cantilever 2 is measured using a capacitive sensor available from ADE Corp., while varying the control voltage within a range of −10 V to +10 V.

Though the moving direction of the cantilever 2 is changed according to variations of the control voltage, its reproduction capacity is little reduced, and there is little variation of the displacement according to the lapse of time. Therefore, since there is little hysteresis and creep in comparison with the head of the conventional atomic force microscope, the present invention has a very high linearity to be able to obtain a desired image through a single initial calibration, and to have a tolerance within about 1%.

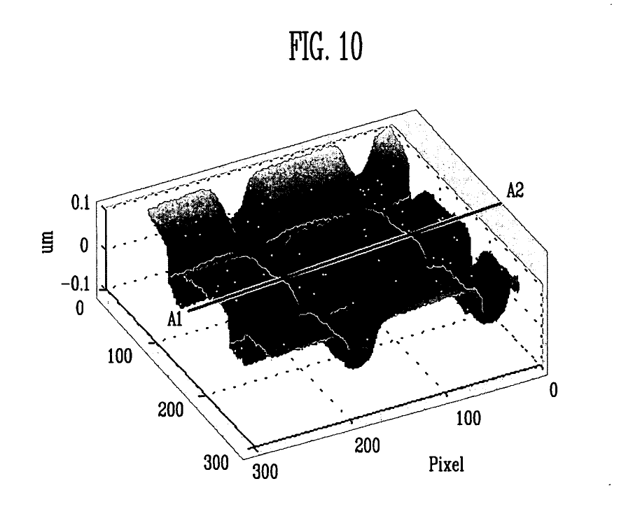

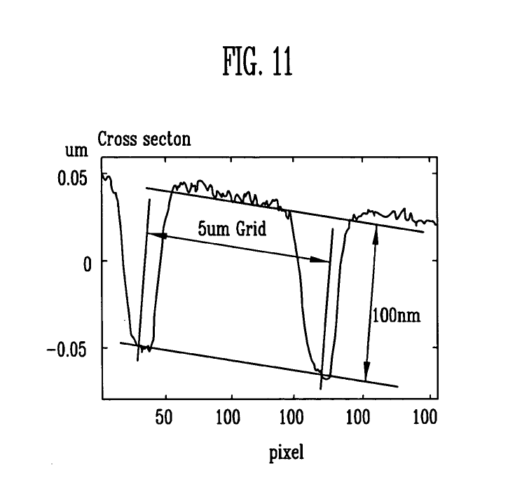

FIG. 10 is a photograph of a grating sample having a size of 5 μm obtained by a personal atomic force microscope in accordance with an exemplary embodiment of the present invention, and FIG. 11 is a cross-sectional view taken along line A1-A2 in FIG. 10.

In measuring a height of 100 nm, a surface image can be obtained with a resolution of less than about 5 nm. An image obtaining speed is in close relationship with a bandwidth of a low pass filter for reducing noise, which is optimized to match with a scanning speed of about 1 Hz.

As can be seen from the foregoing, the personal atomic force microscope in accordance with an exemplary embodiment of the present invention includes: a cantilever provided with a bend detector and for moving a probe; a drive head for moving the cantilever up and down; and a scanner for moving a sample in x- and y-axis directions. The cantilever has a simple structure provided with the bend detector, and the drive head and the scanner are bi-directionally movable and have a large displacement due to the elasticity of the flexible hinge.

The personal atomic force microscope of the present invention has little hysteresis or creep due to its high linearity. Therefore, there is no necessity of a separate sensor system for calibration, and it is possible to obtain a desired image through a single initial calibration.

Since the personal atomic force microscope of the present invention can be used in the conventional system and user environment on the basis of labview, a user can reduce the cost required to establish the system. In addition, since the cantilever, the drive head and the stage have simple structures, it is possible to manufacture the microscope inexpensively, and the microscope can be applied to specimen measurement in biotechnology, a probe type information storage device, an optical information record and reproduction device, and a step-measuring device such as an alpha-step.

Although the present invention has been described with reference to certain exemplary embodiments thereof, it will be understood by those skilled in the art that a variety of modifications and variations may be made to the present invention without departing from the spirit or scope of the present invention defined in the appended claims, and their equivalents.

What is claimed is:

1. A drive head comprising:
a flexible hinge having an elastic portion at a predetermined portion;
a supporter for supporting the flexible hinge and applying a predetermined force to the elastic portion of the flexible hinge;
a yoke connected to the flexible hinge at a position corresponding to the supporter;
a magnet projected from the yoke in one direction; and
a coil fixed on the supporter and overlapping the magnet.

2. The drive head according to claim 1, wherein the elastic portion of the flexible hinge is a groove for smooth bending of the flexible hinge.

3. The drive head according to claim 2, wherein the groove has one shape selected from circular, V and U shapes.

4. The drive head according to claim 1, wherein the elastic portion of the flexible hinge is formed at a lower end of the flexible hinge connected to the supporter.

5. The drive head according to claim 1, wherein the magnet installed in the yoke is formed of a rod or cylinder-shaped permanent magnet.

6. The drive head according to claim 1, wherein the coil is formed to overlap the magnet and surround the inside or outside of the magnet.

7. A personal atomic force microscope comprising:
a probe located on a sample;
a cantilever for moving the probe;
a bend detector with an electric conductivity varying according to a degree of bend of the cantilever;
a controller outputting a control signal according to the electric conductivity provided from the bend detector;
a drive head for moving the cantilever up and down to uniformly maintain a gap between the probe and the sample in response to the control signal; and
a scanner for moving the sample, wherein the drive head comprises: a flexible hinge connected to the cantilever and having an elastic portion at a predetermined portion; a supporter for supporting the flexible hinge and applying a predetermined force to the elastic portion of the flexible hinge; a yoke connected to the flexible hinge at a position corresponding to the supporter; a magnet projected from the yoke in one direction; and a coil fixed on the supporter and overlapping the magnet.

8. The personal atomic force microscope according to claim 7, wherein the bend detector is formed of an ion doped layer having piezoelectric characteristics deposited on the cantilever.

9. The personal atomic force microscope according to claim 7, wherein the controller comprises:
a voltage generator outputting a voltage signal according to the electrical conductivity; and
an actuator outputting the control signal having a predetermined amount of current according to the voltage signal.

10. The personal atomic force microscope according to claim 7, wherein the scanner comprises:
a frame having a rectangular-shaped first opening formed at a center portion and rectangular-shaped second openings formed at each corner of the first opening;
a stage located in the first opening; and
flexible hinges disposed in each of the second openings, having two opposite corners connected to the stage and the frame, and having a rectangular-shaped third opening formed at a center,
wherein each flexible hinge portion composing the flexible hinge is bent in y and x-axis directions as the stage moves in x- and y-axis directions.

11. The personal atomic force microscope according to claim 10, wherein the flexible hinge comprises first to fourth flexible hinge portions connected to each other and spaced apart from the frame outside the second opening.

12. The personal atomic force microscope according to claim 11, wherein each of the flexible hinge portions is formed to have a plurality of circular holes at ends of the hinge portions such that the ends of the flexible hinge portions have a width smaller than that of a center portion.

13. The personal atomic force microscope according to claim 10, wherein the stage moves in x- and y-axis directions by a voice coil motor, and the first to fourth flexible hinge portions opposite to each other are bent in the y- and x-axis direction as the stage moves in the x- and y-axis directions.
